(19) United States
(12) Patent Application Publication
(10) Pub. No.: US 2007/0130134 A1
(43) Pub. Date: Jun. 7, 2007

(54) Natural-language enabling arbitrary web forms

(75) Inventors: William D. Ramsey, Redmond, WA (US); Sanjeev Katariya, Bellevue, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: Microsoft Corporation, Redmond, WA (US)

(21) Appl. No.: 11/294,262

(22) Filed: Dec. 5, 2005

(51) Int. Cl. G06F 17/30

(52) U.S. Cl. 707/4

(57) ABSTRACT

A form filler system and method are provided. The system can allow a user to fill out forms quickly using natural language. A user can navigate to a particular web site and type a natural language query into a text input box. Based, at least in part, upon the query, the system can automatically fill fields in a form associated with a web site. The system includes an input component that receives a natural language query from a user (e.g., a text input box). The system further includes a form filler engine that examines form(s) (e.g., web pages) and extracts the name(s) of input field(s) and possible inputs value(s), if any, in those fields. The form filler engine provides a way to extract the field name(s) from a web page and to fill in values of the form.

### CROSS REFERENCE TO RELATED APPLICATION(S)

This application is related to co-pending U.S. patent application Ser. No. ______, filed Nov. 9, 2005, and entitled, “ADAPTIVE TASK FRAMEWORK” (Atty. Docket No. MS314990.01/MSFTP1226US), co-pending U.S. patent application Ser. No. ______, filed Nov. 9, 2005, and entitled, “ADAPTIVE TASK FRAMEWORK” (Atty. Docket No. MS313887.01/MSFTP1095US), and, co-pending U.S. patent application Ser. No. ______, filed ______, 2005, and entitled, “ADAPTIVE SEMANTIC REASONING ENGINE” (Atty. Docket No. MS313899.01/MSFTP1097US). The entirety of the aforementioned applications is hereby incorporated by reference.

### BACKGROUND

Human languages are rich and complicated, including huge vocabularies with complex grammar and contextual meaning. Machine interpretation of human language, even in a very limited way, is an extremely complex task and continues to be the subject of extensive research. Providing users with the ability to communicate their desires to an automated system without requiring users to learn a machine specific language or grammar would decrease learning costs and greatly improve system usability. However, users become quickly frustrated when automated systems and machines are unable to interpret user input correctly, resulting in unexpected results.

Natural language input can be useful for a wide variety of applications, including virtually every software application with which humans are intended to interact. Typically, during natural language processing the natural language input is separated into tokens and mapped to one or more actions provided by the software application. Each application can have a unique set of actions. Consequently, it can be both time-consuming and repetitive for software developers to draft code to interpret natural language input and map the input to the appropriate action for each application.

The Internet in particular has provided users with a mechanism for obtaining information regarding any suitable subject matter. For example, various websites are dedicated to posting text, images, and video relating to world, national, and/or local news. A user with knowledge of a Uniform Resource Locator (URL) associated with one of such websites can simply enter the URL into a web browser to be provided with the website and access content thereon. Another conventional manner of locating desired information from the Internet is through utilization of a search engine. For instance, a user can enter a word or series of words into a search field and thereafter initiate the search engine (e.g., through depression of a button, one or more keystrokes, voice commands, . . . ). The search engine then utilizes search algorithms to locate websites related to the word or series of words entered by the user into the search field, and the user can then select one of the websites returned by the search engine to review content therein.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A form filler system and method are provided. The system can allow a user to fill out forms quickly using natural language. A user can navigate to a particular web site and type a natural language query into a text input box. Based, at least in part, upon the query and the form, the system can automatically fill fields in a form associate of the web site.

The system includes an input component that receives a natural language query from a user (e.g., a text input box). For example, the input component can include a text input box that provides a way for users to enter information that will be used to fill forms. The system further includes a form filler engine that examines forms (e.g., web pages) and extracts the name(s) of input field(s) and possible input value(s), if any, of those fields. The form filler engine provides a way to extract the field name(s) from a web page and to fill in values of a web page. For example, a particular site can have many field names such as “tcy”, tcff”, etc. to describe the “going to” and “leaving from” fields. The form filler engine can enumerate for each field:
The variable name (e.g., “tcy”)
The corresponding label (e.g., “going to”)
Possible value(s), if any, for example included in drop-down box(es) if the field is a drop-down box (e.g., “Boston”, “Seattle”, etc.)

The system can, optionally, include a semantic reasoning component that is responsible for taking a query and mapping it to the appropriate “slots”. The semantic reasoning component can use statistical and/or heuristic method(s), for example. Thus, the semantic reasoning component maps a natural language query into specific slots with specific values.

In a client-server environment, the semantic reasoning component can be a component of a task server. In a distributed processing environment, at least a portion of the semantic reasoning component can be resident on a user's computer system. In this example, the semantic reasoning component can employ expression managing and/or linguistic models to facilitate form filling.

Accordingly, the system allows a user to navigate to a page and to type in text (e.g., natural language query). Once the page has been loaded and a query has been typed into the system, the system can:
Extract a list of the variables (“tcy”) and labels (“going to”) and possible value(s), if any, from the web form using the form-filler engine;
Pass the query and the list of variables, labels, and possible value(s), if any, to a semantic reasoning component (e.g., which exists either locally or on a server);
Get a mapping of the query to the variables from the semantic reasoning component (e.g., “tcy”=Boston, “tcff”=Seattle); and,
Fill in the values on the web page using the form-filler engine.

The form filler engine can be a browser helper object (BHO). BHOs are objects that bind to a browser at runtime and behave as if they were part of the browser. As a BHO, the form filler engine can insert value(s) into form(s) (e.g., HTML form(s)).

To the accomplishment of the foregoing and related ends, certain illustrative aspects are described herein in connection with the following description and the annexed drawings. These aspects are indicative, however, of but a few of the various ways in which the principles of the claimed subject matter may be employed and the claimed subject matter is intended to include all such aspects and their equivalents. Other advantages and novel features of the claimed subject matter may become apparent from the following detailed description when considered in conjunction with the drawings.

### BRIEF DESCRIPTION OF THE DRAWINGS

FIG. 1 is a block diagram of a form filler system.

FIG. 2 is a block diagram of a form filler system.

FIG. 3 is a diagram of an exemplary task.

FIG. 4 is a diagram of an exemplary slot.

FIG. 5 is a block diagram of an exemplary task framework.

FIG. 6 is a screen shot of an exemplary user interface.

FIG. 7 is a flow chart of a form filler method.

FIG. 8 is a flow chart of a semantic reasoning component method.

FIG. 9 illustrates an example operating environment.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the terms “component,” “handler,” “model,” “system,” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). Computer components can be stored, for example, on computer readable media including, but not limited to, an ASIC (application specific integrated circuit), CD (compact disc), DVD (digital video disk), ROM (read only memory), floppy disk, hard disk, EEPROM (electrically erasable programmable read only memory) and memory stick in accordance with the claimed subject matter.

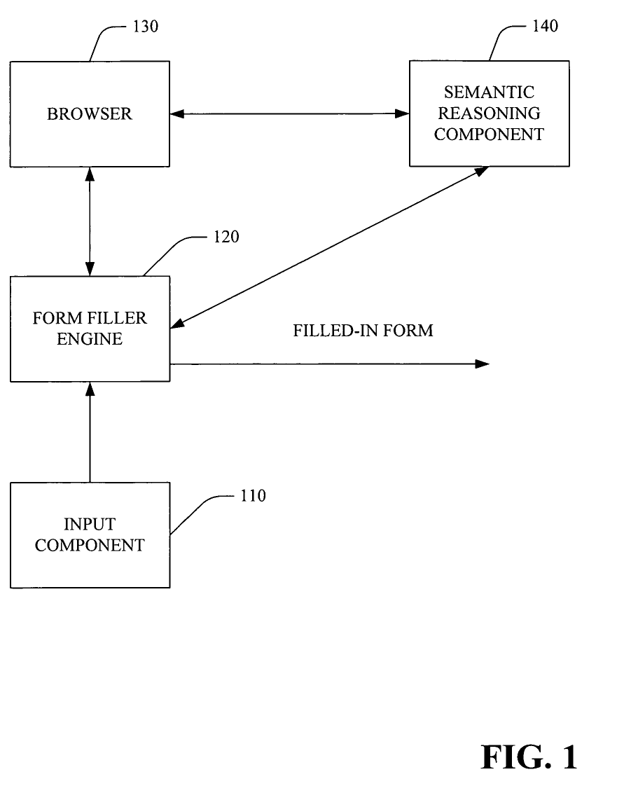

Referring to FIG. 1, a form filler system 100 is illustrated. The system 100 can allow a user to fill out forms quickly using natural language. A user can navigate to a particular web site and type a natural language query into a text input box. Based, at least in part, upon the query and the form, the system 100 can automatically fill fields in a form associated with the web site.

For example, a user can type “I want a flight from Boston to Seattle depart Nov. 23, 2005 return Dec. 20, 2005” and have the appropriate fields filled in automatically. Without natural language, this would require four clicks to input the data. Thus, with the system 100, user(s) can visit, and arbitrary web form and use natural language to fill in value(s) on the form.

The system 100 includes an input component 110 that receives a natural language query from a user (e.g., a text input box). For example, the input component 110 can include a text input box that provides a way for users to enter information that will be used to fill forms. In one example, the text input box can a toolbar input box. In another example, the text input box can be an address box (e.g. where users type URLs). In yet another example, the text input box can be an input box specifically designated for the purpose of natural language input. Those skilled in the art will recognize that while into the input component 110 has been described with respect to a natural language text input, the input component 110 can receive a speech input which is converted into text. The scope of the hereto appended claims is intended to encompass all such input modalities.

The system 100 further includes a form filler engine 120 that examines forms (e.g., web pages) and extracts the name(s) of input field(s) and input value(s), if any, of in those fields. The form filler engine 120 provides a way to extract the field name(s) from a web page and to fill in values of a web page. For example, a particular site can have many field names such as “tcy”, tcff”, etc. to describe the “going to” and “leaving from” fields. The form filler engine 120 can enumerate for each field:
The variable name (e.g., “tcy”)
The corresponding label (e.g., “going to”)
Possible value(s), if any, for example included in drop-down box(es) if the field is a drop-down box (e.g., “Boston”, “Seattle”, etc.)

The form filler engine 120 can further include a method to populate value(s) of the field(s) using their variable name(s). For example, the form filler engine 120 can change the value of the “tcy” field from “Boston” to “Seattle” in response to a query “going to Seattle”.

The system 100 can further, optionally, include a semantic reasoning component 140 that is responsible for taking a query such as “I want a flight from Boston to Seattle” and mapping it to the appropriate “slots” such that [tcy=“Boston”] and [“tcff”=Seattle”]. The semantic reasoning component 140 can use statistical and/or heuristic method(s), for example. Thus, the semantic reasoning component 140 maps a natural language query into specific slots with specific values.

In a client-server environment, the semantic reasoning component 140 can be a component of a task server (not shown), as discussed in greater detail below. In a distributed processing environment, at least a portion of the semantic reasoning component 140 can be resident on a user's computer system (not shown). In this example, the semantic reasoning component 140 can employ expression managing and/or linguistic models to facilitate form filling.

Accordingly, the system 100 allows a user to navigate to a web page having a form and to type in text (e.g., natural language query). Once the page has been loaded and a query has been typed into the system 100, the system 100 can:
1. Extract a list of the variable(s) (“tcy”) and label(s) (“going to”) and possible value(s), if any, from the form using the form-filler engine 120;
2. Pass the query and the list of variable(s), label(s), and possible value(s), if any, to a semantic reasoning component 140 (e.g., which exists either locally and/or on a server);
3. Obtain a mapping of the query to the variable(s) from the semantic reasoning component 140 (e.g., “tcy”=Boston, “tcff”=Seattle); and,
4. Fill in the values on the form using the form-filler engine 120.

In one example the form filler engine 120 can be a browser helper object (BHO). BHOs are objects that bind to a browser 130 at runtime and behave as if they were part of the browser 130. The BHO is a piece of code that effectively becomes part of the browser 130 through the extensibility of the browser 130. As a BHO, the form filler engine 120 can insert value(s) into form(s) (e.g., HTML form(s)). The browser 130 is an application program that is capable of displaying a web page (e.g., Internet Explorer).

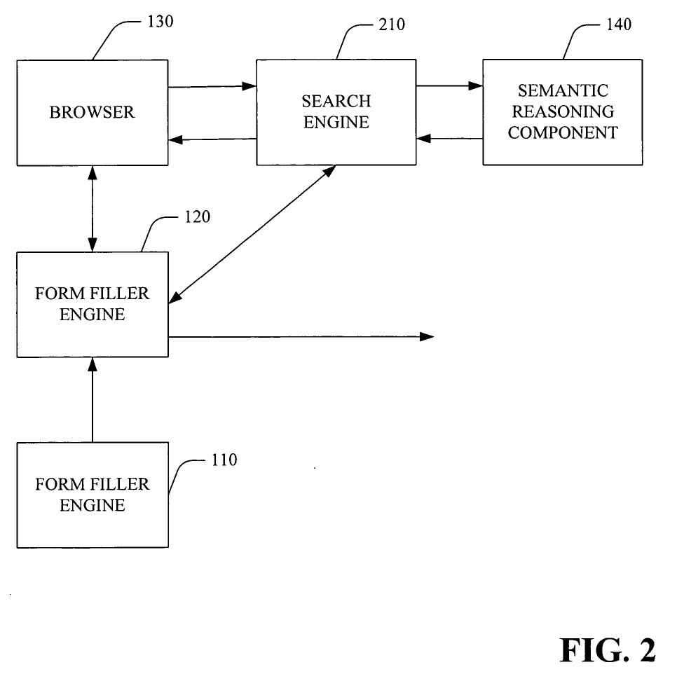

In one example, the browser 130 and the form filler engine 120 communicate directly with a semantic reasoning component 140. In another example, as illustrated in FIG. 2, the browser 130 and/or form filler engine 120 communicate with a search engine 210 that in turn communicates with the semantic reasoning component 140. Further, in a client-server environment, the semantic reasoning component 140 can be a component of a task server (not shown). In a distributed processing environment, at least a portion of the semantic reasoning component 140 can be resident on a user's computer system (not shown).

When a website is loaded, the form filler engine 120 (e.g., BHO) can walk an object model representation of the source code (e.g., HTML) and determine with respect to a form, for example, that there are INPUT box(es), for item(s) such as “Going to:” and “Leaving from:” fields and/or that there are SELECT box(e)s for the time of day containing elements such as “Morning”, “Noon”, “Evening” and “Anytime”. The form filler engine 120 can extract value(s) from input selection box(es), if any.

The form filler engine 120 can communicate with the search engine 210 to pass a natural language query and a list of variable(s), label(s) and possible value(s), if any, to the semantic reasoning engine 140. Via the search engine 210, the form filler engine 120 can receive a mapping of the query to the variables from the semantic reasoning component 140. Thereafter, based on the mapping, the form filler engine 120 can fill in values on the form. For example, the form filler engine 120 can insert a value of “Boston” into an INPUT box named “tcy”, if the form filler engine 120 is notified that Value(tcy)=“Boston”.

Semantic Reasoning Component 140

The semantic reasoning component 140 is responsible for taking a query, a list of variable(s), label(s), and possible values, if any, and mapping the query to the appropriate “slots”. The semantic reasoning component 140 then maps the query to the variable(s) and can fill in parameter value(s) based on the query such as determining that the variable “tcy” should have the value “Boston”.

Overview of an Exemplary Semantic Reasoning Component 140

In one example, the variable(s), label(s) and value(s), if any, are treated as a “task” by the semantic reasoning component 140. In this example, the semantic reasoning component 140 is responsible for:
a. Receiving an input query;
b. Receiving a task (e.g., list of variable(s), label(s) and/or value(s), if any);
c. Filling out slot values given the task and the input query;

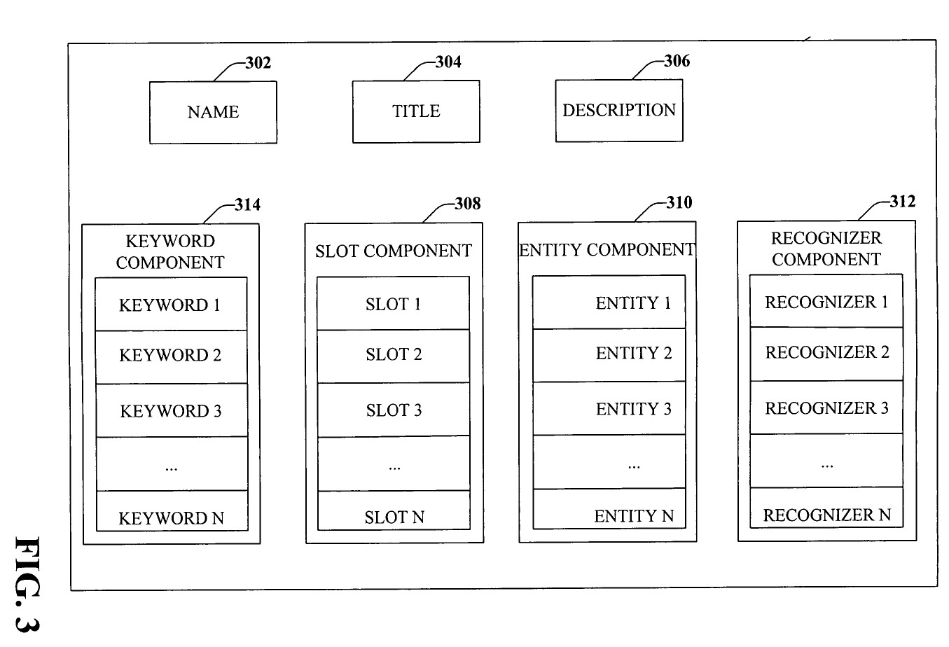

Referring to FIG. 3, an exemplary task 300 is illustrated. The task 300 can be generated by the semantic reasoning component 140 in response to a user's query. For example, the task 300 can include a name 302 that identifies the task 300 (e.g., a task for booking airline flights may be named “BookFlight”). The task 300 can also include a title 304, for example, that can be displayed to users. Additionally, the task 300 can include a description 306 that briefly describes the task 300. The description 306 can be displayed to users either to allow the users to select the appropriate task 300 or confirm that the appropriate task 300 has been selected. For example, the name, title and description can be implemented using alphanumeric text strings.

The task 300 can include an entity component 310. The entity component 310 can include one or more named entities. A named entity, as used herein, is a token that is known to have a specific meaning. The named entity can be task specific or can be utilized with multiple tasks. The task 300 can include a named entity (NE) recognizer component 312. The NE recognizer component 312 can include one or more recognizers capable of matching tokens or portions of the natural language input to the entities included in the entity component 310. The NE recognizers 312 are capable of recognizing tokens corresponding to the named entities contained within the entities component 310. These tokens have a specific task meaning. Recognizers may be general or may be specific to a certain category of tokens. For example, a city recognizer may include a list of names (e.g., Seattle, Boston). Similarly, a date recognizer may be capable of recognizing and interpreting dates, such as “Jun. 14, 2005.” The software developer may define certain recognizers when specifying a task.

The task 300 can also include a keyword component 314. The keyword component 314 can include one or more keywords. Keywords can be used to select a task 300 from a set of tasks. For example, the “BookFlight” task keyword component 314 can include keywords such as “Book Flight,” “airline” and the like. The keywords can be determine by the software developer or automatically generated by the semantic reasoning component 140. In addition, the semantic reasoning component 140 can add additional keywords to the keyword component 314 based upon natural language input, user actions and/or user feedback. Furthermore, the keywords may be weighted, such that the presence of certain keywords in the query is more likely to surface certain tasks. Such weight can also be used to rank or order a selected group of tasks.

The task 300 can also include a slot component 308 that specifies or defines slots for information required for the task. The slot component 308 can provide a mechanism for defining parameters used by the task. For example, a task that books airline flights may include slots for the arrival city, the departure city, the flight date and time. The slot component 308 can include any integer number of slots, from zero to N. Typically, information from the natural language input is used to fill the slots.

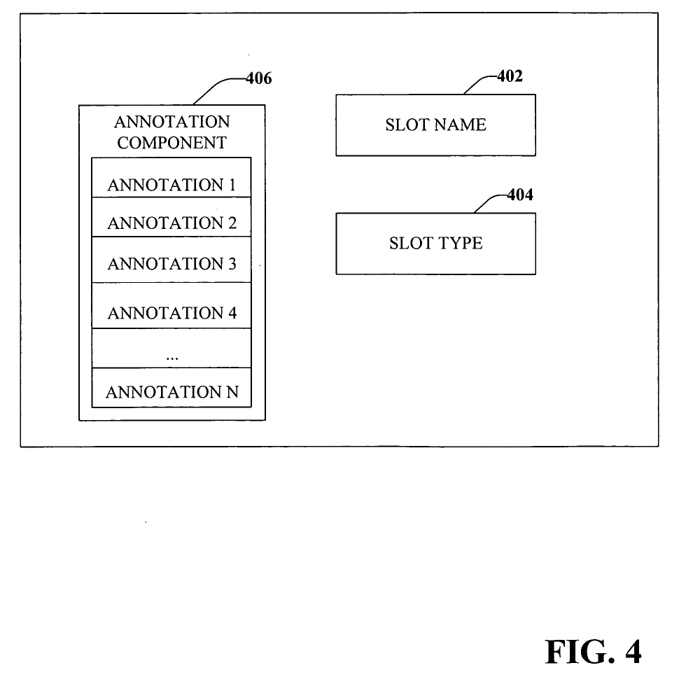

Turning next to FIG. 4, an exemplary slot 400 is illustrated. A slot 400 can include a slot name 402 that identifies the slot 400. For example, the BookFlight task discussed above can include slots named “DestinationCity,” “ArrivalCity” and “Date.” The slot 400 can also include a slot type 404. Slot type 404 indicates the type of the value of the slot data. Types can include integers, real numbers, textual strings and enumerated types (e.g., type “City” can include a list of city names).

The slot 400 can also include an annotation component 406. The annotation component 406 can include one or more annotations. Annotations are tokens that mark or indicate the significance of other tokens. The annotation component 406 identifies an annotation token and uses that information to interpret other tokens within the natural language input. For example, the token “from” when contained within a natural language input string that maps to a “BookFlight” task indicates that the token that follows is likely to contain the name of the departure city. Annotations may appear either before or after the relevant token. For example, the token “departure city” when contained within a natural language input string that maps to a “BookFlight” task indicates that the token that precedes it is likely to contain the name of the departure city. Consequently, the phrase “leaving from Boston” and “Boston departure city” can both be interpreted to fill the departure city slot with the value “Boston.” Annotations which appear before the token are called pre-indicators, while annotations which follow the relevant token are called post-indicators. The annotation component 406 can recognize task system defined annotations as well as task specific annotations.

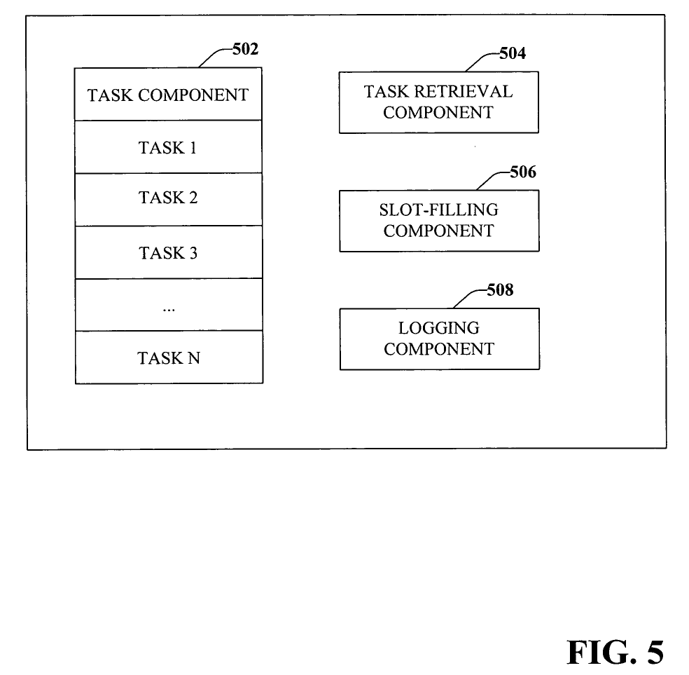

Next, referring to FIG. 5, an exemplary task framework 500 is illustrated. The framework 500 can include a task component 502 that includes one or more tasks, as described previously. The framework 500 can be a component of the semantic reasoning component 140.

Tasks can be generated by one or more applications or tasks can be generated automatically by the task framework 500. In addition, the task framework 500 may update or modify tasks generated by application(s). The task component 502 can be a flat file, a database or any other structure suitable for containing the data for one or more tasks.

The task framework 500 can include a task retrieval component 504. The task retrieval component 504 uses the query to select one or more tasks from the collection of tasks contained within the task component 502. The task retrieval component 504 may determine the appropriate task to be retrieved from the task component 502 based upon keywords in the query. The collection of tasks in the task component 502 can be indexed based upon the task keywords. The tokens contained within the query can be used to select an appropriate task or set of tasks. The application can also include additional information with the query. For example, the application could pass user context information to the framework to be used in the selection of the appropriate task. The task retrieval component 504 can use a variety of methodologies to select appropriate tasks. The task retrieval component 504 can be trained to improve performance based upon user actions and responses to the selected tasks.

In addition, the task framework 500 can include a slot-filling component 506. The slot-filling component 506 can be responsible for providing the best matching of the list of tokens from the natural language input or query with the task parameters. Typically, a slot-filling component 506 can receive a list of tokens and one or more tasks. The slot-filling component 506 can generate one or more possible mappings of the tokens to the slots of the task. The slot-filling component 506 can generate a score or rank for each of the possible mappings of tokens to task slots. The slot-filling component 506 can use a mathematical model, algorithm or function to calculate a score or rank for mappings. The slot-filling component 506 can utilize a heuristic function, a hidden Markov model, a Naïve Bayes based model, Maximum Entropy/Minimum Divergence Models (MEMD), blending strategies, linear discriminative models or any combination thereof to calculate a score for a mapping of tokens to a task.

The slot-filling component 506 can include a method responsible for taking the natural language input, culture information, a list of tokens, a list of named entities, a task and a predetermined maximum number of desired solutions. Culture information can include information such as the writing system and formatting utilized by the relevant culture. Named entities identify tokens with a specific meaning to the slot-filling system (e.g., Boston). The slot-filling component 506 can produce a list of up to the maximum number of requested semantic solutions with a semantic solution representing a mapping of tokens to slots that can be used by the search engine 210.

Optionally, the task framework 500 can also include a logging component 508. Tasks can pass information or feedback to the task framework 500 after completion of the task or during task processing. The logging component 508 stores the feedback information. This information can be used to train the task framework 500 and improve system performance. The feedback from tasks can include user actions. The task framework 500 can include a defined intent interface to facilitate feedback.

In addition, the task framework 500 or the slot-filling component 506 can include one or more GlobalRecognizers that provide the ability to recognize tokens that have special meaning to the task system in general. For example, the token “Boston” has special meaning as the city of Boston, Mass. The GlobalRecognizers property provides a set of recognizer components that identify special tokens, making them available throughout the entire system and across multiple tasks. For example, there may be several tasks that utilize “city,” “date” or “number” entities. Entities are a mechanism for providing type information. For example the “city” entity includes a set of annotations (e.g., “city,” “place,” and “town”). Occurrences of the annotations within the list of tokens indicate the likelihood of a “city” entity. GlobalRecognizers allows such entities or special tokens to be defined once rather than for each individual task.

In summary, keywords are terms that might be used to surface a task. Slots are parameter values that may or may not be filled by the user Query. Slots are uniquely specified by their Name and Type.

Additionally, preIndicators are words that might disambiguate slots by occurring before a value “to Boston” would prefer the “Arrival City” slot over the “Departure City” slot even though Boston maps to CITY and can be a value for either slot. PostIndicators are words that might disambiguate slots by occurring before a value “from Boston” would prefer the “Departure City” slot over the “Arrival City” slot even though Boston maps to CITY and can be a value for either slot. Consider the example of Table 1:

TABLE 1

```
<Task Name=“ReserveFlight”>
<Keywords>cheap;tickets;flights;flight;vacations</Keywords>
<Slots>
    <Slot name=“Arrival City” type= “CITY”>
<PreIndicators>to, going into</PreIndicators>
<PostIndicators>arrival city</PostIndicators>
</Slot>
    <Slot name=“Departure City” type= “CITY”>
<PreIndicators>from, originating in</PreIndicators>
<PostIndicators>departure city</PostIndicators>
</Slot>
    <Slot name=“Arrival Time” type= “TIME”>
<PreIndicators>arriving at</PreIndicators>
<PostIndicators>arrival time</PostIndicators>
    </Slot>
    <Slot name=“ Departure Time” type= “TIME”>
<PreIndicators>leaving at</PreIndicators>
<PostIndicators>departure time</PostIndicators>
    </Slot>
    <Slot name=“Adults” type= “INTEGER”>
<PreIndicators> </PreIndicators>
<PostIndicators> adult, adults</PostIndicators>
    </Slot>
    <Slot name=“Seniors” type= “INTEGER”>
<PreIndicators> </PreIndicators>
<PostIndicators>senior,seniors</PostIndicators>
    </Slot>
    <Slot name=“Children” type= “INTEGER”>
<PreIndicators> </PreIndicators>
<PostIndicators>children,child,kid,kids</PostIndicators>
    </Slot>
</Slots>
</Task>
```

Given the schema of Table 1, the following queries match the ReserveFlight Task:
“I want a flight from Boston with a 8:30 PM departure time with 2 adults and 1 child”
“buy a ticket from Seattle to New York leaving at 5:15 PM”

Additionally, as discussed previously, the semantic reasoning component 140 can employ user feedback to learn from user behavior such that if users start entering queries such as “departing Boston for Seattle” to mean “Departure City”=“Boston” and “Arrival City”=“Seattle”. The semantic reasoning component 140 will automatically learn the pattern “departing <Departure City> for <Arrival City>” without needing to explicitly add new Pre or Post indicators to the task definition.

Exemplary User Interface

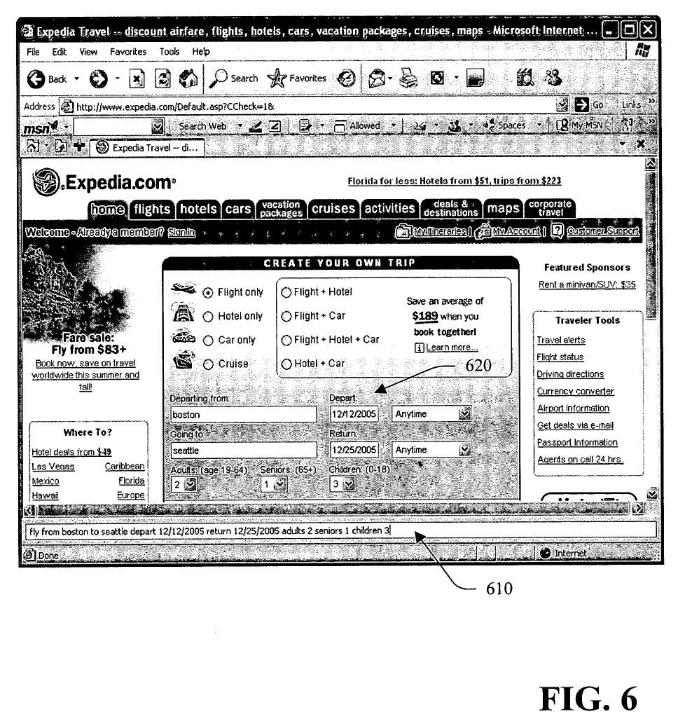

Referring briefly to FIG. 6, an exemplary user interface 600 is illustrated. In this example, a text input box 610 is employed by the input component 110 to receive user input. The user interface 600 includes a form 620 which the form filler engine 120 has populated based, at least in part, upon the user's query into the text input box 610.

It is to be appreciated that the system 100, the input component 110, form filler engine 120, the browser 130, the semantic reasoning component 140. the system 200, and/or the search engine 210.

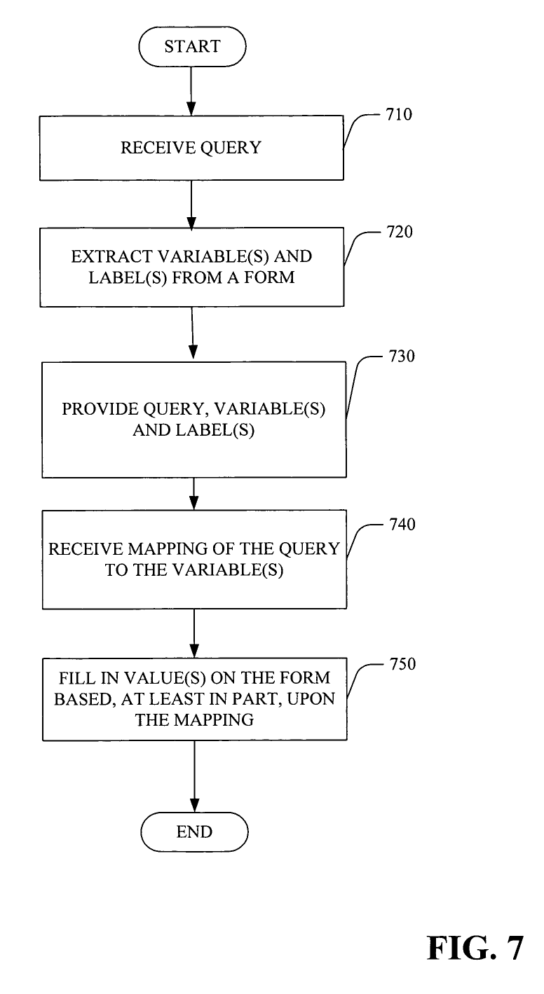

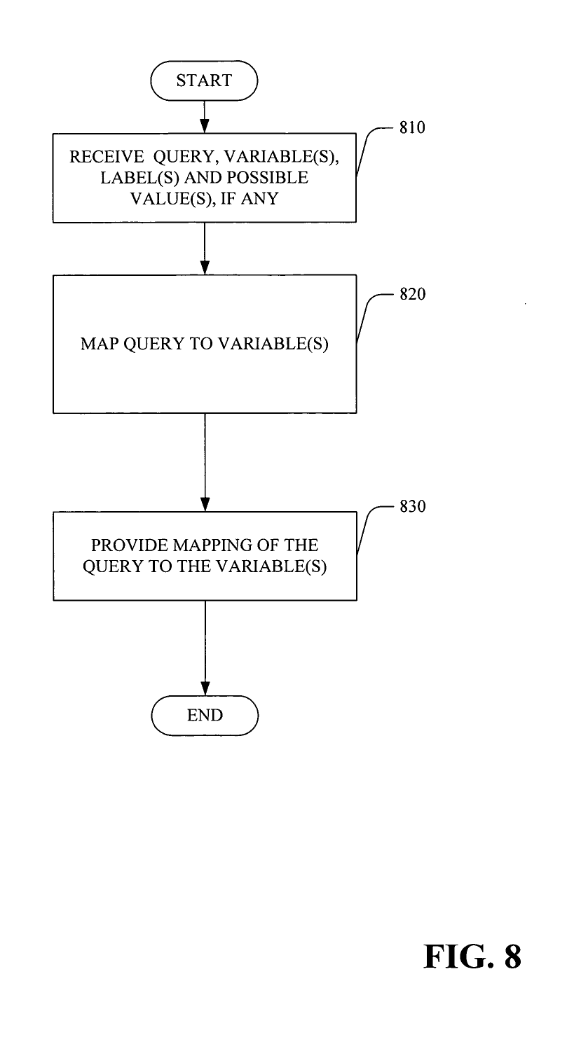

Turning briefly to FIGS. 7 and 8, methodologies that may be implemented in accordance with the claimed subject matter are illustrated. While, for purposes of simplicity of explanation, the methodologies are shown and described as a series of blocks, it is to be understood and appreciated that the claimed subject matter is not limited by the order of the blocks, as some blocks may, in accordance with the claimed subject matter, occur in different orders and/or concurrently with other blocks from that shown and described herein. Moreover, not all illustrated blocks may be required to implement the methodologies.

The claimed subject matter may be described in the general context of computer-executable instructions, such as program modules, executed by one or more components. Generally, program modules include routines, programs, objects, data structures, etc. that perform particular tasks or implement particular abstract data types. Typically the functionality of the program modules may be combined or distributed as desired in various embodiments.

Referring to FIG. 7, a form filler method is illustrated. At 710, a query (e.g., natural language query) is received, for example, from an input component 110. At 720, variable(s) and label(s) are extracted from a form. Optionally, possible value(s) of the variable(s) can also be extracted from the form (e.g., drop down list of possible value(s) associated with a particular variable). At 730, the query, the variable(s) and the label(s) are provided, for example, to a semantic reasoning component 140. Additionally, possible value(s), if any, can further be provided.

At 740, a mapping of the query to the variable(s) is received, for example from the semantic reasoning component 140. At 750, value(s) on the form are filled-in based, at least in part, upon the mapping.

Next, turning to FIG. 8, a semantic reasoning component method is illustrated. At 810, a query and variable(s), label(s), and possible value(s), if any, are received. At 820, the query is mapped to the variable(s). At 830, the mapping of the query to the variable(s) is provided.

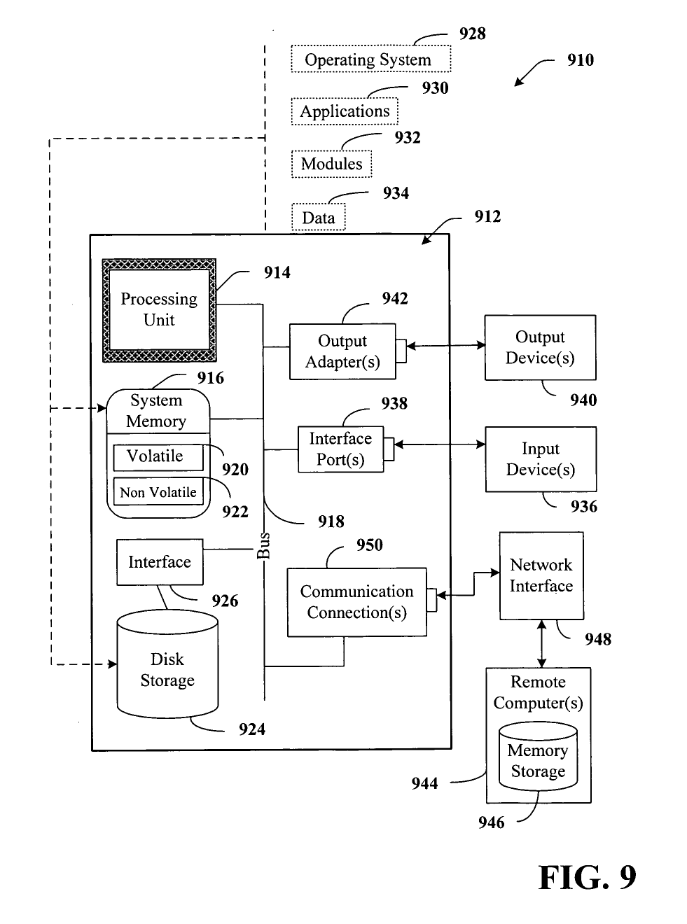

In order to provide additional context for various aspects of the claimed subject matter, FIG. 9 and the following discussion are intended to provide a brief, general description of a suitable operating environment 910. While the claimed subject matter is described in the general context of computer-executable instructions, such as program modules, executed by one or more computers or other devices, those skilled in the art will recognize that the claimed subject matter can also be implemented in combination with other program modules and/or as a combination of hardware and software. Generally, however, program modules include routines, programs, objects, components, data structures, etc. that perform particular tasks or implement particular data types. The operating environment 910 is only one example of a suitable operating environment and is not intended to suggest any limitation as to the scope of use or functionality of the claimed subject matter. Other well known computer systems, environments, and/or configurations that may be suitable for use with the claimed subject matter include but are not limited to, personal computers, hand-held or laptop devices, multiprocessor systems, microprocessor-based systems, programmable consumer electronics, network PCs, minicomputers, mainframe computers, distributed computing environments that include the above systems or devices, and the like.

With reference to FIG. 9, an exemplary environment 910 includes a computer 912. The computer 912 includes a processing unit 914, a system memory 916, and a system bus 918. The system bus 918 couples system components including, but not limited to, the system memory 916 to the processing unit 914. The processing unit 914 can be any of various available processors. Dual microprocessors and other multiprocessor architectures also can be employed as the processing unit 914.

The system bus 918 can be any of several types of bus structure(s) including the memory bus or memory controller, a peripheral bus or external bus, and/or a local bus using any variety of available bus architectures including, but not limited to, an 8-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Universal Serial Bus (USB), Advanced Graphics Port (AGP), Personal Computer Memory Card International Association bus (PCMCIA), and Small Computer Systems Interface (SCSI).

The system memory 916 includes volatile memory 920 and nonvolatile memory 922. The basic input/output system (BIOS), containing the basic routines to transfer information between elements within the computer 912, such as during start-up, is stored in nonvolatile memory 922. By way of illustration, and not limitation, nonvolatile memory 922 can include read only memory (ROM), programmable ROM (PROM), electrically programmable ROM (EPROM), electrically erasable ROM (EEPROM), or flash memory. Volatile memory 920 includes random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM).

Computer 912 also includes removable/nonremovable, volatile/nonvolatile computer storage media. FIG. 9 illustrates, for example a disk storage 924. Disk storage 924 includes, but is not limited to, devices like a magnetic disk drive, floppy disk drive, tape drive, Jaz drive, Zip drive, LS-100 drive, flash memory card, or memory stick. In addition, disk storage 924 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 924 to the system bus 918, a removable or non-removable interface is typically used such as interface 926.

It is to be appreciated that FIG. 9 describes software that acts as an intermediary between users and the basic computer resources described in suitable operating environment 910. Such software includes an operating system 928. Operating system 928, which can be stored on disk storage 924, acts to control and allocate resources of the computer system 912. System applications 930 take advantage of the management of resources by operating system 928 through program modules 932 and program data 934 stored either in system memory 916 or on disk storage 924. It is to be appreciated that the claimed subject matter can be implemented with various operating systems or combinations of operating systems.

A user enters commands or information into the computer 912 through input device(s) 936. Input devices 936 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 914 through the system bus 918 via interface port(s) 938. Interface port(s) 938 include, for example, a serial port, a parallel port, a game port, and a universal serial bus (USB). Output device(s) 940 use some of the same type of ports as input device(s) 936. Thus, for example, a USB port may be used to provide input to computer 912, and to output information from computer 912 to an output device 940. Output adapter 942 is provided to illustrate that there are some output devices 940 like monitors, speakers, and printers among other output devices 940 that require special adapters. The output adapters 942 include, by way of illustration and not limitation, video and sound cards that provide a means of connection between the output device 940 and the system bus 918. It should be noted that other devices and/or systems of devices provide both input and output capabilities such as remote computer(s) 944.

Computer 912 can operate in a networked environment using logical connections to one or more remote computers, such as remote computer(s) 944. The remote computer(s) 944 can be a personal computer, a server, a router, a network PC, a workstation, a microprocessor based appliance, a peer device or other common network node and the like, and typically includes many or all of the elements described relative to computer 912. For purposes of brevity, only a memory storage device 946 is illustrated with remote computer(s) 944. Remote computer(s) 944 is logically connected to computer 912 through a network interface 948 and then physically connected via communication connection 950. Network interface 948 encompasses communication networks such as local-area networks (LAN) and wide-area networks (WAN). LAN technologies include Fiber Distributed Data Interface (FDDI), Copper Distributed Data Interface (CDDI), Ethernet/IEEE 802.3, Token Ring/IEEE 802.5 and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 950 refers to the hardware/software employed to connect the network interface 948 to the bus 918. While communication connection 950 is shown for illustrative clarity inside computer 912, it can also be external to computer 912. The hardware/software necessary for connection to the network interface 948 includes, for exemplary purposes only, internal and external technologies such as, modems including regular telephone grade modems, cable modems and DSL modems, ISDN adapters, and Ethernet cards.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A form filler system, comprising:
an input component that receives a natural language query from a user;
a form filler engine that extracts at least one variable and at least one label associated with a form of a web page, provides the query and extracted variable and label to a semantic reasoning component, receives a mapping of the query to the variable from the semantic reasoning component, and, fills in a value of the form based on the mapping.

2. The system of claim 1, further comprising a browser that is an application program capable of displaying the web page.

3. The system of claim 3, the form filler engine is a browser helper object that binds to a browser at runtime.

4. The system of claim 1, further comprising the semantic reasoning component that maps the query to the variable.

5. The system of claim 4, the input component, the form filler engine and the semantic reasoning component resident on a user's computer system.

6. The system of claim 4, the semantic reasoning component further comprises a slot-filling component that provides a slot value based upon a particular form and the query.

7. The system of claim 6, the slot-filling component utilizes a ranking function based on a heuristic or statistically based to calculate a score for a mapping of the query to the variable.

8. The system of claim 1, the input component comprising a text input box that facilitates entry of the natural language query.

9. The system of claim 8, the text input box is a toolbar input box.

10. The system of claim 8, the text input box is a URL address box.

11. The system of claim 1, the input component receives the query as speech input, the input component converts the speech to speech input to text.

12. The system of claim 1, the form filler engine further extracts a possible input value associated with the variable and provides the possible input value to the semantic reasoning component.

13. The system of claim 1, the form filler engine creates an object model corresponding to a schema associated with the web page.

14. The system of claim 1, the form filler engine includes a method to populate the value of a field using the variable name.

15. The system of claim 1, further comprising a search engine that receives the query from the form filler engine and provides the query to the semantic reasoning engine.

16. A form filler method, comprising:
receiving a query;
extracting a variable and a label from a form;
providing the query, the variable and the label;
receiving a mapping of the query to the variable; and,
filling in a value on the form based, at least in part, upon the mapping.

17. The method of claim 16, further comprising extracting a possible value of the variable from the form.

18. A form filler system, comprising:
means for displaying a form of a web page;
means for receiving a natural language query from a user;
means for extracting at least one variable and at least one label associated with the form;
means for providing the query and extracted variable and label to a semantic reasoning component,
means for mapping the query to the variable;
means for receiving a mapping of the query to the variable from the semantic reasoning component; and,
means for filling in a value of the form based on the mapping.

19. The system of claim 18, means for mapping the query to the variable utilizes a ranking function based on a heuristic or statistically based to calculate a score for mapping of the query to the variable.

20. The system of claim 18, the means for receiving a natural language query, the means for extracting at least one variable and at least one label associated with the form, and, the means for mapping the query to the variable resident on a user's computer system.
